(19) United States
(12) Patent Application Publication
(10) Pub. No.: US 2010/0028630 A1
(43) Pub. Date: Feb. 4, 2010

(54) Particle, Method For Manufacturing The Particle, Ink Composition Containing The Particle, And Recorded Matter Formed With The Ink Composition

(75) Inventors: Takayoshi KAGATA, Shiojiri-shi (JP); Tsuyoshi SANO, Shiojiri-shi (JP)

Correspondence Address: LADAS & PARRY, 26 West 61st Street, New York, NY, 10023, US

(73) Assignee: SEIKO EPSON CORPORATION

(21) Appl. No.: 12/511,405

(22) Filed: Jul. 29, 2009

(30) Foreign Application Priority Data
Jul. 31, 2008 (JP) 2008-197484

(51) Int. Cl. B32B 3/10; B05D 7/22; B32B 5/16; C09D 11/10

(52) U.S. Cl. 428/207; 427/230; 427/238; 523/201

(57) ABSTRACT

A particle includes a hollow resin particle defined by an outer shell having a hollow interior, made of a first resin. The outer shell has an outer diameter of 0.2 to 1.0 μm and an inner diameter/outer diameter ratio of 0.2 or more. The outer shell contains a second resin in the hollow interior.

### BACKGROUND

1. Technical Field

The present invention relates to particles, and particularly to a white particle. The invention also relates to a method for manufacturing the particle, an ink composition containing the particle, and a recorded matter formed with the ink composition.

2. Related Art

U.S. Pat. No. 4,880,465 and Japanese Unexamined Patent Application Publication Nos. 2000-103995, 2000-239585 and 2005-154568 disclose white ink compositions containing hollow polymer particles as a white pigment. The hollow polymer particle is defined by an outer shell made of a liquid-permeable resin, having a hollow interior. The hollow polymer particle has a difference refractive index between the outer shell and the hollow interior, and the difference between the refractive indices cause light scattering to produce a hiding power.

However, the known white particle is disadvantageously liable to be crushed due to the internal structure when it is used in a white ink composition to form an image on a recording medium. If the particles in the composition are crushed, the whiteness of the resulting image is reduced.

### SUMMARY

An advantage of some aspects of the invention is that it provides a particle difficult to crush, and particularly a white particle difficult to crush and having superior whiteness. Another advantage of some aspects of the invention is that it provides an ink composition having superior rub fastness, and particularly a white ink composition having superior rub fastness and capable of producing clear white images.

According to an aspect of the invention, a particle is provided which includes a hollow resin particle defined by an outer shell having a hollow interior, made of a first resin. The outer shell has an outer diameter of 0.2 to 1.0 μm and an inner diameter/outer diameter ratio of 0.2 or more. The outer shell contains a second resin in the hollow interior.

The present inventors have found that when an image is formed with a type of hollow resin particles, each defined by a resin outer shell having a hollow interior and having an outer diameter of 0.2 to 1.0 μm and an inner diameter/outer diameter ratio of 0.2 or more, the rub fastness of the resulting image is notably reduced because the particles are easy to crush. The inventors have further found that by introducing another resin into the hollow interior of the hollow resin particle, a structure not easily crushed even by external impact can be achieved.

Furthermore, the inventors have found that by controlling the composition of the resin introduced to the hollow interior of the hollow resin particle, the refractive indices of the resins, and the ratio of the hollow interior, the resulting particle can be difficult to crush and can exhibit high whiteness.

The second resin may form a hollow inner shell disposed adjacent to the inner surface of the outer shell.

In this particle, preferably, the ratio of the diameter of the hollow interior to the inner diameter of the outer shell is 0.8 or less.

The second resin may be selected from the group consisting of fluorocarbon resins, methacrylate resins, acrylate resins, styrene resins and polycarbonate resins.

Preferably, the first resin has a higher refractive index than the second resin.

Preferably, the first resin has a refractive index of 1.40 to 1.60, and the second resin has a refractive index of 1.30 to 1.45.

According to another aspect of the invention, a method for manufacturing the above particle is provided. The method includes immersing the hollow resin particle in a solution containing the second resin to introduce the second resin into the hollow interior of the hollow resin particle, and subsequently drying and heating the hollow resin particle.

According to still another aspect of the invention, a method for manufacturing the above particle is provided. The method includes holding the hollow resin particle in a vacuum, subsequently immersing the hollow resin particle in a solution containing the second resin to introduce the second resin into the hollow interior of the hollow resin particle, and subsequently drying and heating the hollow resin particle.

According to a further aspect of the invention, an ink composition containing the above particle is provided.

According to a still further aspect of the invention, an ink jet recording ink composition containing the above particle is provided.

Furthermore, a recorded matter including an image formed with the ink composition or the ink jet recording ink composition is provided.

The particle according to an embodiment of the present invention has a structure difficult to crush. Accordingly, an ink composition containing the particle can form an image having superior rub fastness. In addition, by controlling the resin composition forming the particle, the refractive index of the resin, and the ratio of the hollow interior, the resulting particle can be difficult to crush and can exhibit superior whiteness. A white ink composition containing the particle as white particle can form clear white image having high rub fastness.

### BRIEF DESCRIPTION OF THE DRAWING

The invention will be described with reference to the accompanying drawing, wherein like numbers reference like elements.

The FIGURE is a schematic sectional view of a particle including a hollow resin particle made of a first resin containing a second resin in the hollow interior so as not to fill the hollow interior fully.

### DESCRIPTION OF EXEMPLARY EMBODIMENTS

### Particle

A particle according to an embodiment of the present invention includes an outer shell made of a first resin having a hollow interior. The outer shell or hollow resin particle contains a second resin in the hollow interior.

The hollow resin particle has an outer diameter (mean particle size) of 0.2 to 1.0 μm, preferably 0.4 to 1.0 μm, and more preferably 0.4 to 0.8 μm. If the outer diameter is more than 1.0 μm, the particles may sediment and lead to degraded dispersion stability, or may clog the ink jet recording head to degrade the reliability. In contrast, particles having an outer diameter of less than 0.2 μm tend to be insufficient in whiteness.

The inner diameter/outer diameter ratio of the hollow resin particle is 0.2 or more, and preferably 0.4 or more. A particle having an inner diameter/outer diameter ratio of less than 0.2 is not easily crushed, which is an advantageous characteristic feature of the invention. In contrast, as the inner diameter/outer diameter ratio becomes closer to 1, the crushing of the hollow resin particle occurs more notably. The suitable inner diameter of the hollow resin particle can be about 0.1 to 0.8 μm.

The outer diameter (mean particle size) of the hollow resin particle can be measured with a particle size distribution analyzer based on the laser diffraction/scattering method. A particle size distribution meter using dynamic light scattering (for example, Microtrack UPA manufactured by Nikkiso Co., Ltd.) may be used as the laser diffraction/scattering particle size distribution analyzer. The inner diameter of the hollow resin particle can be directly measured by transmission electron microscopy (TEM) or scanning electron microscopy (SEM).

Any hollow resin particle, including known particles made of, for example, styrene-acrylic resin, may be used in embodiments of the invention without particular limitation. For example, the hollow resin particle disclosed in U.S. Pat. No. 4,880,465 or Japanese Unexamined Patent Application Publication No. 3,562,754 can be suitably used.

The hollow resin particle contains a second resin in the hollow interior thereof. From the viewpoint of whiteness and of preventing crushing, it is preferable that the hollow resin particle contain the second resin in part of the hollow interior (air phase) rather than the second resin fills the hollow interior.

The FIGURE is a schematic sectional view of a particle including a hollow resin particle having a hollow interior containing a second resin so as not to fill the hollow interior fully. In this particle, the second resin forms an inner shell 2 along the inner surface of the outer shell 1, and the inner shell 2 has a hollow interior 3. The presence of the hollow interior (air phase) 3 helps the inner shell 2 between the outer shell 1 and the hollow interior 3 to scatter light. Consequently, the resulting particle can exhibit enhanced hiding power and high whiteness. From the viewpoint of both preventing crushing and enhancing the whiteness, the second resin is present such that the ratio (d2/d1) of the diameter d2 of the hollow interior 3 to the inner diameter d1 of the outer shell 1 defining the hollow resin particle can be preferably 0.8 or less, more preferably 0.4 to 0.7. The diameter d2 of the hollow interior 3 corresponds to the inner diameter of the particle after introducing the second resin. The inner diameter of the hollow resin particle mentioned herein is directly measured by transmission electron microscopy (TEM) or scanning electron microscopy (SEM).

For use of the particle in an ink composition, it is preferable that the outer shell and the inner shell of the particle be made of liquid-permeable resins, in addition to having a hollow interior. Consequently, if the particle is present in an aqueous ink composition, the hollow interior is filled with an aqueous medium. Since the particle filled with an aqueous medium has substantially the same specific gravity as the external aqueous medium, the particle does not sink in the aqueous ink composition and, thus, can maintain the dispersion stability. Thus, the particle can enhance the storage stability and the ejection stability of the ink composition.

When an aqueous ink composition containing the particles is ejected onto a recording medium, such as paper, the aqueous medium in the particles is dried to form hollow interiors. The particles thus contain air. The particles form a resin layer and an air layer having different refractive indices, and thus scatter light effectively to produce white color.

The second resin present in the hollow interior of the hollow resin particle is not particularly limited. In view of the refractive index and the solubility, however, the second resin can be preferably at least one selected from the group consisting of fluorocarbon resins, such as polytetrafluoroethylene, Teflon (registered trademark) and Cytop (produced by Asahi Glass); acrylate resins, such as polyacrylate resin and sodium polyacrylate resin; methacrylate reins, such as polymethyl methacrylate resin; styrene resins, such as polystyrene; and polycarbonate resins, and more preferably selected from among amorphous fluorocarbon resins, such as Cytop (produced by Asahi Glass).

The second resin preferably has a refractive index of 1.30 to 1.45, and more preferably 1.30 to 1.35, in order to ensure whiteness. In order to ensure whiteness also, the first resin forming the outer shell preferably has a higher refractive index than the second resin. The difference in refractive index between the first resin forming the outer shell and the second resin forming the inner shell is preferably 0.01 to 0.20, and more preferably 0.10 to 0.20, form the viewpoint of ensuring whiteness. The first resin of the outer shell generally has a refractive index of about 1.40 to 1.60. The refractive index can be measured with a spectroscopic ellipsometer.

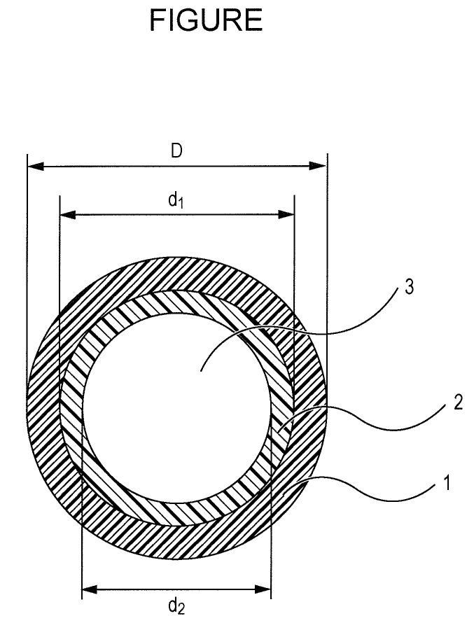

The particle of the present embodiment can be prepared by any method without particular limitation. For example, the second resin may be introduced into the hollow interior of the hollow resin particle, or a resin core particle may first be formed of the second resin, and then the outer shell is formed of the first resin to cover the resin core particle. For forming the particle having the structure shown in FIG. 1, it is easy and thus preferable that the second resin is introduced into the hollow interior of the hollow resin particle.

The hollow resin particle can be prepared by a known method without particular limitation. For example, the hollow resin particle can be prepared by so-called emulsion polymerization. In this method, for example, a vinyl monomer, a surfactant, a polymerization initiator and an aqueous disperse medium are stirred together in a nitrogen atmosphere while being heated, and thus an emulsion of hollow resin particles is prepared.

Exemplary vinyl monomers include nonionic monoethylene unsaturated monomers, such as styrene, vinyl toluene, ethylene, vinyl acetate, vinyl chloride, vinylidene chloride, acrylonitrile, (meth)acrylamide, and (meth)acrylic ester. Exemplary (meth)acrylic esters include methyl acrylate, methyl methacrylate, ethyl(meth)acrylate, butyl(meth)acrylate, 2-hydroxyethyl methacrylate, 2-ethylhexyl(meth)acrylate, benzyl(meth)acrylate, lauryl(meth)acrylate, oleyl(meth)acrylate, palmityl(meth)acrylate, and stearyl(meth)acrylate.

The vinyl monomer may be a bifunctional vinyl monomer. Examples of the bifunctional vinyl monomer include divinylbenzene, allyl methacrylate, ethylene glycol dimethacrylate, 1,3-butane-diol dimethacrylate, diethylene glycol dimethacrylate, and trimethylolpropane trimethacrylate. By polymerizing a foregoing monofunctional vinyl monomer and a bifunctional vinyl monomer to form many cross-links, the resulting hollow resin particle can exhibit heat resistance and solvent resistance as well as light scattering characteristics.

The surfactant can be any substance that can form a molecular aggregate such as micelle in water. Examples of the surfactant include anionic surfactants, nonionic surfactants, cationic surfactants, and amphoteric surfactants.

The polymerization initiator can be a known compound soluble in water, such as hydrogen peroxide or potassium persulfate.

The aqueous disperse medium can be water that may or may not contain a hydrophilic organic solvent.

In order to introduce the second resin into the hollow interior of the hollow resin particle, either method (a) or method (b) bellow can be applied.

### Second Resin Introduction Method (a)

First, dried hollow resin particles (outer shells) are immersed in a resin solution (treatment solution) containing the second resin at a concentration of preferably 20% to 30% by mass, more preferably 20% to 25% by mass. The immersion may be performed for 12 to 48 hours and preferably 24 to 48 hours.

Subsequently, the treatment solution is filtered to separate the hollow resin particles. The hollow resin particles are washed with a solvent and dried in the atmosphere. The drying is performed preferably at a temperature of 50 to 200° C., more preferably 80 to 150° C., for preferably 12 to 48 hours, more preferably 24 to 48 hours. The second resin introduced into the hollow interior of the hollow resin particle is cured to fix by light (active light) or a chemical reaction depending on the type of the resin. If the second resin is cured by heating, it is heated preferably at 50 to 200° C., more preferably at about 70° C., for 1 to 10 hours, more preferably for about 5 hours. The diameter of the hollow interior can be controlled to a desired value by adjusting the concentration of the resin solution containing the second resin. Alternatively, the above procedure may be repeated several times to obtain a desired diameter of the hollow interior.

### Second Resin Introduction Method (b)

Before dried hollow resin particles (outer shells) are immersed in a resin solution in Method (a), the dried hollow particles may be held in a vacuum to form voids in the particles. In this method, the second resin concentration in the resin solution can be low and is preferably 10% to 25% by mass, more preferably 10% to 20% by mass. The hollow resin particles are immersed in this resin solution for about 24 to 48 hours. After the immersion, the subsequent steps can be performed in the same manner as in Method (a).

Preferably, the particles containing the second resin in the hollow interiors of the hollow resin particles, produced by either the above Method (a) or (b) are dispersed in water, and the resulting dispersion is stored.

### Ink Composition

An ink composition according to an embodiment of the invention contains the above-described particles, and preferably, the particles are white particles. The ink composition will now be described.

If the particles contained in the ink composition are white particles, the particle content (solid content) is preferably 5% to 20% by mass, more preferably 8% to 15% by mass, relative to the total mass of the ink composition. If the white particle content (solid content) is more than 20% by mass, the ink composition may, for example, clog the ink jet recording head to degrade the reliability. In contrast, if the white particle content is less than 5% by mass, a sufficient whiteness may not be obtained.

The ink composition also contains a resin for fixing the particles. Such resins include acrylic resins (for example, Almatex produced by Mitsui Chemicals) and urethane resins (for example, WBR-022U produced by Taisei Fine Chemical).

The resin content is preferably 0.5% to 10% by mass, more preferably 0.5% to 3.0% by mass, relative to the total mass of the ink composition.

Preferably, the ink composition contains at least one selected from the group consisting of alkanediols and glycol ethers. Alkanediols and glycol ethers can increase the wettability of the record surface of the recording medium to enhance the permeability of the ink.

Preferred alkanediols are 1,2-alkanediols having a carbon number in the range of 4 to 8, such as 1,2-butanediol, 1,2-pentanediol, 1,2-hexanediol, 1,2-heptanediol, and 1,2-octanediol. More preferably, 1,2-alkanediols having a carbon number of 6 to 8 are used, such as 1,2-hexanediol, 1,2-heptanediol, and 1,2-octanediol. These alkanediols have high permeability to the recording medium.

Exemplary glycol ethers include lower alkyl ethers of polyhydric alcohol, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Triethylene glycol monobutyl ether can particularly provide a higher recording quality.

The alkanediol and/or glycol ether content is preferably 1% to 20% by mass, more preferably 1% to 10% by mass, relative to the total mass of the ink composition.

Preferably, the ink composition contains an acetylene glycol-based or polysiloxane-based surfactant. Acetylene glycol-based and polysiloxane-based surfactants can increase the wettability of the record surface of the recording medium to enhance the permeability of the resulting ink.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, such as OLFINEs E1010, STG and Y (produced by Nissin Chemical Industry); and SURFYNOLs 104, 82, 465, 485, 485 and TG (produced by Air Products and Chemicals Inc.).

The polysiloxane-based surfactant may be a commercially available product, such as BYK-347 or BYK-348 (produced by BYK).

The ink composition may contain other surfactants, such as anionic surfactant, nonionic surfactant, and amphoteric surfactant.

The surfactant content is preferably 0.01% to 5% by mass, more preferably 0.1 to 0.5% by mass, relative to the total mass of the ink composition.

Preferably, the ink composition contains a polyhydric alcohol. In the use of the ink composition for an ink jet recording apparatus, the polyhydric alcohol hinders the ink from drying to prevent the ink from clogging the ink jet recording head.

Exemplary polyhydric alcohols include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane.

The polyhydric alcohol content is preferably 0.1% to 3.0% by mass, more preferably 0.5% to 2.0% by mass, relative to the total mass of the ink composition.

Preferably, the ink composition contains a tertiary amine. The tertiary amine can serve as a pH adjuster and can easily control the pH of the ink composition.

For example, triethanolamine may be used as the tertiary amine.

The tertiary amine content is preferably 0.01% to 10% by mass, more preferably 0.1% to 2% by mass, relative to the total mass of the ink composition.

The ink composition generally contains water as the solvent. The water is preferably pure water or ultrapure water, such as ion exchanged water, ultrafiltered water, osmotic water, or distilled water. Particularly preferably, the water is sterilized by irradiating with UV light or adding hydrogen peroxide. Such water prevents occurrence of molds and bacteria for a long term.

The ink composition may further contain other additives including a fixer such as water-soluble rosin, an antifungal agent or preservative such as sodium benzoate, an antioxidant or ultraviolet light adsorbent such as an allophanate, a chelating agent, and an oxygen adsorbent, if necessary. These additives may be used singly or in combination.

The ink composition can be prepared in the same manner as known pigment inks, using a known apparatus, such as ball mill, sand mill, attritor, basket mill or roll mill. For preparation, it is preferable that coarse particles be removed with a membrane filter or a mesh filter.

The ink composition can form an image by being applied onto a recording medium. Examples of the recording medium include paper, cardboard, textile, sheet or film, plastics, glass, and ceramics.

The ink composition can be used for any application without particular limitation, and can be used for a variety of ink jet recording methods. Ink jet recording methods include thermal ink jet method, piezoelectric ink jet method, continuous ink jet method, roller application, and spray application.

The ink composition is not limited to white ink containing white particles. The ink composition may be prepared by combining the particles according to an embodiment of the invention and another color material. Such an ink composition can form color images other than the white image, having high rub fastness.

### Recorded Matter

The invention provides a recorded matter formed with the ink composition according to an embodiment of the invention. The recorded matter exhibits superior rub fastness. In particular, recorded matter formed with a white ink composition according to an embodiment of the invention has a white image exhibiting superior rub fastness and clearness.

### EXAMPLES

The invention will be described in detail with reference to Examples. However, it is not limited to the Examples.

### 1. Preparation of White Particles

Examples 1 to 9 of the white particle shown in Table 3 were prepared by introducing a second resin into the hollow interiors of hollow resin particles made of styrene-acrylic resin (first resin) by the following introduction method (1). Comparative Examples 1 and 2 shown in Table 3 are particles not containing the second resin in the hollow interiors.

Commercially available particles “SX8782 (D)” or “SX866 (B)” (both produced by JSR) shown in Table 3 were used as the hollow resin particles. SX8782 (D) is of aqueous dispersion type and has a solid content of 28%. Its particle has an outer diameter of 1.0 μm and an inner diameter of 0.8 μm. SX866 (B) is of aqueous dispersion type and has a solid content of 20%. Its particle has an outer diameter of 0.3 μm and an inner diameter of 0.2 μm.

### Resin Introduction Method (1)

Hollow resin particles dried at 30° C. for 3 days were allowed to stand in a vacuum for an hour, and then 30 g of the particles were immersed in 10% to 20% by mass solution of amorphous fluorocarbon polymer Cytop (produced by Asahi Glass) in a fluorocarbon solvent (for example, Fluorinert FC-72, produced by 3M) for 10 hours. The resulting liquid was filtered through a 5 μm filter to separate the hollow resin particles. After being washed with a fluorocarbon solvent, the hollow resin particles were heated at 200° C. for 5 hours. The resulting particles were dispersed in water, thus preparing desired particles containing the second resin.

Second resin-containing particles of other examples were prepared in the same manner as above except that the second resin introduced into the hollow interiors and the cleaning solvent for washing the particles after filtration were replace with polymethyl methacrylate solution (solvent: toluene) and polystyrene solution (solvent: toluene), respectively.

Examples 2, 4 and 6, which produced particles having an inner diameter of 0 after introducing the second resin, were obtained by repeating the above procedure.

### Resin Introduction Method (2)

Hollow resin particles were dried at 30° C. for 3 days, and 30 g of the dried particles were immersed in 20% to 30% by mass solution of amorphous fluorocarbon polymer Cytop (produced by Asahi Glass) in a fluorocarbon solvent (for example, Fluorinert FC-72, produced by 3M) for 24 hours. The resulting liquid was filtered through a 5 μm filter to separate the hollow resin particles. After being washed with a fluorocarbon solvent, the hollow resin particles were heated at 70° C. for 5 hours. The resulting particles were dispersed in water, thus preparing desired particles containing the second resin.

Second resin-containing particles of other examples were prepared in the same manner as above except that the second resin introduced into the hollow interiors and the cleaning solvent for washing the particles after filtration were replace with polymethyl methacrylate solution (solvent: toluene) and polystyrene solution (solvent: toluene), respectively.

Examples 2, 4 and 6, which produced particles having an inner diameter of 0 after introducing the second resin, were obtained by repeating the above procedure.

### 2. Evaluation of Particles

For evaluating the degree of crushing and the whiteness, white ink compositions, each containing any one of the white particles prepared in Examples 1 to 9 and Comparative Examples 1 and 2 were prepared, and an image was formed with the resulting ink composition on a recording medium. The resulting printed matters were evaluated for the rub fastness and the whiteness.

### 2-1. Evaluation of Degree of Crushing

The black ink chamber of the cartridge of an ink jet printer PX-G930 manufactured by Seiko Epson was filled with the white ink composition containing a type of white particles of Examples 1 to 9 and Comparative Examples 1 and 2 shown in Table 3. The ink cartridge was loaded in the printer, and printing tests were performed. Commercially available ink cartridges were used as ink cartridges other than the black ink cartridge. These were intended for dummies, and were not involved in the evaluation.

The composition of the white ink composition subjected to the printing test is shown in Table 1.

TABLE 1

| Ingredient | Content (mass %) |
|---|---|
| White particles of any one of | 10 |
| Examples 1 to 9 and Comparative | |
| Examples 1 and 2 | |
| WBR-022U | 1 |
| Glycerin | 10 |
| 1,2-Hexanediol | 3 |
| Triethanolamine | 0.5 |
| BYK-348 | 0.5 |
| Ion exchanged water | Balance |
| Total | 100 |

Then, printing was performed on ink jet recording paper (OHP sheet, manufactured by Seiko Epson) at a resolution of 720×720 dpi. The printed pattern was a 100% duty-solid pattern.

The duty mentioned herein is calculated from the following equation:

Duty(%)=Number of dots actually printed/(vertical resolution×lateral resolution)×100

(In the equation, the number of dots actually printed represents a number of dots actually printed per unit area; the vertical resolution and the lateral resolution are each a resolution per unit area; 100% duty represents the maximum mass of monochromatic ink for a pixel.)

The OHP sheet on which the white ink composition had been printed was dried at room temperature for an hour. After drying, rubbing test was performed with a nonwoven fabric. The rubbing test with a nonwoven fabric is a method performed by rubbing a print surface with a nonwoven fabric (Bemcot Lab, manufactured by Asahi Kasei Fibers) on which a load of 200 g is placed. The evaluation criteria were as follows:

### Evaluation Criteria of Rubbing Test With Bemcot Lab

AA: Not crushed at all even by rubbing 10 times or more.

A: Crushed by rubbing 7 to 9 times.

B: Crushed by rubbing 4 to 6 times.

C: Crushed by rubbing 2 to 3 times.

D: Crushed by rubbing once.

### 2-2. Evaluation of Whiteness

The black ink chamber of the cartridge of an ink jet printer PX-G930 manufactured by Seiko Epson was filled with the white ink composition containing a type of white particles of Examples 1 to 9 and Comparative Examples 1 and 2 shown in Table 3. The ink cartridge was loaded in the printer, and printing tests were performed. Commercially available ink cartridges were used as ink cartridges other than the black ink cartridge. These were intended for dummies, and were not involved in the evaluation.

The composition of the white ink composition subjected to the printing test is shown in Table 2.

TABLE 2

| Ingredient | Content (mass %) |
|---|---|
| White particles of any one of | 10 |
| Examples 1 to 9 and | |
| Comparative Examples 1 and 2 | |
| WBR-022U | 1 |
| Glycerin | 10 |
| 1,2-Hexanediol | 3 |
| Triethanolamine | 0.5 |
| BYK-348 | 0.5 |
| Ion exchanged water | Balance |
| Total | 100 |

Then, printing was performed on ink jet recording paper (OHP sheet, manufactured by Seiko Epson) at a resolution of 720×720 dpi. The printed pattern was a 100% duty-solid pattern.

The OHP sheet on which the white ink composition had been printed was dried at room temperature for an hour. After drying, the printed matter was put on a standard black paper, and the color was measured with 938 Spectrodensitometer manufactured by X-rite using a D50 light source. The whiteness was evaluated from the lightness (L*) thus measured. The evaluation criteria of whiteness were as follows:

Evaluation criteria of Whiteness

AA: L*≧75

A: 72≦L*<75

B: 68≦L*<72

C: 65≦L*<68

D: L*<65

TABLE 3

| | | | | | | | | | | | | | Comparative | |
|---|---|---|---|---|---|---|---|---|---|---|---|---|---|---|
| | Refractive | Outer | Inner | Example | | | | | | | | | Example | |
| | index | diameter | diameter | 1 | 2 | 3 | 4 | 5 | 6 | 7 | 8 | 9 | 1 | 2 |
| White hollow | 1.5 | 1.0 μm | 0.8 μm | √ | √ | | | √ | √ | √ | | √ | √ | |
| resin particles (a) | | | | | | | | | | | | | | |
| White hollow | 1.5 | 0.3 μm | 0.2 μm | | | √ | √ | | | | √ | | | √ |
| resin particles (b) | | | | | | | | | | | | | | |
| Amorphous | 1.34 | | | √ | √ | √ | √ | | | | | √ | | |
| fluorocarbon | | | | | | | | | | | | | | |
| resin (c) | | | | | | | | | | | | | | |
| Polymethyl | 1.49 | | | | | | | √ | √ | | √ | | | |
| methacrylate | | | | | | | | | | | | | | |
| Polystyrene | 1.59 | | | | | | | | | √ | | | | |

| | | | | | | | | | | | |
|---|---|---|---|---|---|---|---|---|---|---|---|
| Inner diameter after introducing resin (μm) | 0.5 | 0 | 0.1 | 0 | 0.5 | 0 | 0.5 | 0.1 | 0.7 | N/A | N/A |
| Whiteness | A | B | B | C | B | C | C | C | A | AA | A |
| Crushing | A | AA | B | A | B | A | B | B | C | D | D |

(a) SX8782 (D) produced by JSR, Outer diameter: 1.0 μm, Inner diameter: 0.8 μm, aqueous dispersion
(b) SX866 (B) produced by JSR, Outer diameter: 0.3 μm, Inner diameter: 0.2 μm, aqueous dispersion
(c) Cytop produced by Asahi Glass

Furthermore, the second resin was introduced by the above-described Resin Introduction Method (2), and similar results were obtained.

Table 3 shows that the particles containing the second resin in the hollow interiors of the hollow resin particles can be prevented from being crushed.

In addition, the particle having the structure in which the second resin is present in the hollow interior of the hollow resin particle so as not to fill the hollow interior fully, as shown in FIG. 1, and in which the refractive index of the second resin and the ratio of the hollow interior are adjusted can be prevented from being crushed, and can exhibit superior whiteness.

1. A particle comprising:
a hollow resin particle defined by an outer shell having a hollow interior, made of a first resin, the outer shell having an outer diameter of 0.2 to 1.0 m and an inner diameter/outer diameter ratio of 0.2 or more, the outer shell containing a second resin in the hollow interior.

2. The particle according to claim 1, wherein the second resin forms an inner shell having a hollow interior, disposed adjacent to the inner surface of the outer shell.

3. The particle according to claim 2, wherein the ratio of the diameter of the hollow interior to the inner diameter of the outer shell is 0.8 or less.

4. The particle according to claim 1, wherein the second resin is selected from the group consisting of fluorocarbon resins, methacrylate resins, acrylate resins, styrene resins and polycarbonate resins.

5. The particle according to claim 1, wherein the first resin has a higher refractive index than the second resin.

6. The particle according to claim 1, wherein the first resin has a refractive index of 1.40 to 1.60, and the second resin has a refractive index of 1.30 to 1.45.

7. A method for manufacturing the particle as set forth in claim 1, the method comprising:
immersing the hollow resin particle in a solution containing the second resin to introduce the second resin into the hollow interior of the hollow resin particle; and
subsequently drying and heating the hollow resin particle.

8. A method for manufacturing the particle as set forth in claim 1, the method comprising:
holding the hollow resin particle in a vacuum;
subsequently immersing the hollow resin particle in a solution containing the second resin to introduce the second resin into the hollow interior of the hollow resin particle; and
subsequently drying and heating the hollow resin particle.

9. An ink composition comprising the particle as set forth in claim 1.

10. An inkjet recording ink composition comprising the particle as set forth in claim 1.

11. A recorded matter comprising an image formed with the ink composition as set forth in claim 9.

12. A recorded matter comprising an image formed with the ink jet recording ink composition as set forth in claim 10.
